(19) United States
(12) Patent Application Publication
(10) Pub. No.: US 2009/0244446 A1
(43) Pub. Date: Oct. 1, 2009

(54) LIQUID CRYSTAL DISPLAY DEVICE

(75) Inventors: Koutarou YASUDA, Kanagawa (JP); Megumi SEKIGUCHI, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Minato-ku (JP)

(21) Appl. No.: 12/412,563

(22) Filed: Mar. 27, 2009

(30) Foreign Application Priority Data
Mar. 31, 2008 (JP) 2008-091897

(51) Int. Cl. G02F 1/1335

(52) U.S. Cl. 349/96; 349/119

(57) ABSTRACT

A liquid crystal display device containing a first polarizing plate, a first retardation film, a liquid crystal cell, a second retardation film, and a second polarizing plate in this order from a light incident side, wherein an absorption axis of the first polarizing plate and an absorption axis of the second polarizing plate are orthogonal to each other, and wherein the first retardation film is configured to change a polarization state of light to a state of a fixed point before the light enters the liquid crystal cell so as to allow the liquid crystal cell transmit the light having the polarization state of the fixed point

### BACKGROUND OF THE INVENTION

1. Field of the Invention

The present invention relates to a Vertically Aligned (VA) mode liquid crystal display device which is not influenced by variation in the retardations Rth in the thickness direction of liquid crystal cells, and can maintain excellent display performance.

2. Description of the Related Art

As liquid crystal display devices, various modes of liquid crystal display devices have been proposed. Particularly, the VA mode comes to have contrast and wide viewing angle characteristics of all round view as a wide viewing angle mode, and has been in widespread use as TV application. Moreover, recently over 30 inch, wide displays appear in the market. In the VA mode liquid crystal display devices, optical anisotropic films having various characteristics are used for optical compensation so as to reduce light leakage in the oblique direction in black display, and color shift.

The value of optical property Rth of a VA cell is important to produce such viewing angle compensation film for VA mode. The Rth of the VA cell relates to a refractive index difference of liquid crystals in a cell and a cell thickness. The cell thicknesses vary in a range of approximately ±10% upon production. As a result, the Rth of the VA cell reflects individual difference or in-plane variation.

The polarization state of light as passed through a liquid crystal display device, in which a retardation film for VA mode is used, represented by use of Poincare sphere is shown in FIG. 1. An axis connecting the point 3 and the point 4 corresponds to the Stokes parameter S₁ which reflects a tendency for the polarization to resemble either a horizontal P-state (whereupon S₁>0) or a vertical one (in which case S₁<0). When the beam displays no preferential orientation with respect to these axes (S₁=0), it may be elliptical at ±45°, circular, or unpolarized. Similarly, S₂ implies a tendency for the light to resemble a P-state oriented in the direction of +45° (when S₂>0) or in the direction of −45° (when S₂<0) or neither (S₂=0). In the same way S₃ reveals a tendency of the beam toward right-handedness (when S₃>0), left-handedness (when S₃<0), or neither (S₃₌₀).

In FIG. 1, the polarization state of incident light is shown with a point 1, and the polarization state is changed as the light is transmitted through a retardation film and a liquid crystal cell so as to be shown with an optical extinction point 2, where the polarization is completely compensated, i.e., no light leakage. Practically, the changed polarization state lies at a distance from the extinction point on a Poincare sphere. The larger the distance, the more significantly the light leakage occurs, adversely affecting the display performance.

In the liquid crystal display device, the change in the polarization state of the light after passing through the liquid crystal cell is shown on the Poincare sphere as to rotate at an angle proportional to Rth based on a straight line connecting a point 3 and a point 4 as a rotational axis.

In the case where the Poincare sphere of FIG. 1 is unfolded, an arc connecting the point 3 and the point 4 is shown with a straight line as in FIGS. 2A, 3A and 4A. For example, Japanese Patent (JP-B) No. 3330574 and Japanese Patent Application Laid-Open (JP-A) No. 2003-344856 disclose that as the polarization state is significantly changed in the liquid crystal cell, when Rths of the liquid crystal cells vary, the polarization state deviates as is shown with a solid line and a dotted line in FIGS. 2A, 3A and 4A. As a result, the state of outgoing light does not match to the extinction point on the Poincare sphere, adversely affecting display performance.

Here, FIG. 2B shows a case of two biaxial retardation films having the same optical properties, FIGS. 3B and 4B show cases of one biaxial retardation film. FIG. 3B is a case where no retardation film is disposed on the other side of a cell from the side where a biaxial retardation film is disposed. FIG. 4B is a case where a retardation film (negative C plate) is disposed on the other side of a cell from the side where the biaxial retardation film is disposed. In FIGS. 2A, 3A and 4A, an arrow 5 denotes the change of the polarization state by the retardation Rth of the liquid crystal cell, an arrow 6 denotes the change of polarization state by the retardation film, wherein the dotted line represents the change of the polarization state when the cell thickness or Rth does not vary, and the solid line represents the change of the polarization state when the cell thickness or Rth is larger than the average value. 1 denotes a point showing the polarization state of incident light, and 2 denotes an optical extinction point, at which the polarization state the brightness of the light becomes the darkest, and a double-headed arrow denotes light leakage. The arrow represents the change of the polarization state by the retardation Rth of the liquid crystal cell, wherein the polarization state rotates around the axis connecting the point 4 and the point 3 corresponding to the retardation Rth of the liquid crystal cell. In FIGS. 2B, 3B and 4B, 11, 12, 13, 14 and 15 respectively denote a first polarizing plate, a first retardation film, a liquid crystal cell, a second retardation film, and a second polarizing plate, and an arrow represents incident light. An absorption axis of the first polarizing plate 11 and a slow axis of the first retardation film 12 are orthogonal to each other.

Therefore, at present it is demanded to provide a Vertically Aligned (VA) mode liquid crystal display device which is not influenced by the variation in the retardation Rth in the thickness direction of the liquid crystal cell, and can maintain excellent display performance.

### BRIEF SUMMARY OF THE INVENTION

An object of the present invention is to provide a Vertically Aligned (VA) mode liquid crystal display device which is not influenced by variation in retardations Rth in the thickness direction of liquid crystal cells and can maintain excellent display performance free from light leakage, by changing a polarization state of incident light before the light enters a liquid crystal cell to a state represented at a fixed point on the Poincare sphere, and then passing the light through the liquid crystal cell

The inventors of the present invention have diligently studied to solve the above problems and found that, as shown in FIGS. 5A and 5B, the state of the incident light 1 before changed by a liquid crystal cell in the liquid crystal display device is changed to a state of a fixed point 3 or 4, i.e. a fixed point (S₁=+1 or −1, S₂=0, S₃=0) by a first retardation film 12, thereby fixing the state of the light at substantially the same point, or a fixed point, even though the retardations Rth of the liquid crystal cells vary, and then changed to the state of the light at an extinction point 2 by a second retardation film 14, so as not to be influenced by variation in the retardations Rth of the liquid crystal cells, thereby maintaining excellent display performance. In FIG. 5, 11 denotes a first polarizing plate, 12 denotes a first retardation film, 13 denotes a liquid crystal cell, 14 denotes a second retardation film, and 15 denotes a second polarizing plate.

The fixed point means a point which is located on the rotational axis on a Poincare sphere when a change of the polarization state of the light after passing through the retardation film is represented on the Poincare sphere, and is not influenced by a phase difference value but maintains the same polarization state as those before passing through the retardation film.

The extinction point means, especially in a configuration including a polarizing plate, a point showing that the polarization state of the light after passing through the polarization plate located in the light outgoing side is linearly polarized when a change of the polarization state of the light is represented on the Poincare sphere. When the polarization state is such linearly polarized state before passing through the polarizing plate located in the light outgoing side, the light is completely compensated, thereby occurring no light leakage. As the polarization state is represented closer to the extinction point on the Poincare sphere, the light leakage decreases, that is, high display performance is attained.

The present invention is made on the basis of the findings by the inventors of the present invention, and means for solving the above-mentioned problems are as follows.

<1> A liquid crystal display device containing a first polarizing plate, a first retardation film, a liquid crystal cell, a second retardation film and a second polarizing plate in this order from a light incident side, wherein an absorption axis of the first polarizing plate and an absorption axis of the second polarizing plate are orthogonal to each other, and wherein the first retardation film is configured to change a polarization state of light to a state of a fixed point before the light enters the liquid crystal cell so as to allow the liquid crystal cell transmit the light having the polarization state of the fixed point.

<2> The liquid crystal display device according to <1>, wherein the polarization state of light before the light enters the liquid crystal cell is one of a p-polarized light and a s-polarized light.

<3> The liquid crystal display device according to <1>, wherein the first retardation film has a slow axis vertical to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: 300 nm<Rth(550)<600 nm, and wherein the second retardation film has a slow axis parallel to the absorption axis of the second polarizing plate located in the light outgoing side, and has Re(550) of: 100 nm<|Re(550)|<300 nm, and Rth (550) of −600 nm<Rth(550)<−300 nm.

<4> The liquid crystal display device according to <1>, wherein the first retardation film has a slow axis parallel to the absorption axis of the second polarizing plate located in the light outgoing side, and has an in-plane retardation Re at a wavelength of 550 nm, Re(550), of 100 nm<|Re(550)|<300 nm, and a retardation Rth in the thickness direction at a wavelength of 550 nm, Rth(550), of: −600 nm<Rth(550)<−300 nm, and wherein the second retardation film has a slow axis parallel to the absorption axis of the second polarizing plate located in the light outgoing side, and has Re(550) of: 100 nm<|Re(550)|<300 nm, and Rth(550) of: −600 nm<Rth(550)<−300 nm.

<5> The liquid crystal display device according to <1>, wherein the first retardation film has a slow axis vertical to the absorption axis of the second polarizing plate located in the light outgoing side, and has an in-plane retardation Re at a wavelength of 550 nm, Re(550), of 100 nm<|Re(550)|<300 nm, and a retardation Rth in the thickness direction at a wavelength of 550 nm, Rth(550), of 300 nm<Rth(550)<600 nm, and wherein the second retardation film has a slow axis vertical to the absorption axis of the second polarizing plate located in the light outgoing side, and has Re(550) of: 100 nm<|Re(550)|<300 nm, and Rth(550) of: 300 nm<Rth(550)<600 nm.

<6> The liquid crystal display device according to <1>, wherein the first retardation film has a slow axis parallel to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: −600 nm<Rth(550)<−300 nm, and wherein the second retardation film has a slow axis vertical to the absorption axis of the second polarizing plate located in the light outgoing side, and has Re(550) of: 100 nm<|Re(550)|<300 nm, and Rth(550) of 300 nm<Rth(550)<600 nm.

<7> The liquid crystal display device according to <1>, wherein the first retardation film has a slow axis vertical to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: −600 nm<Rth(550)<−300 nm, and wherein the second retardation film has a slow axis vertical to the absorption axis of the second polarizing plate located in the light outgoing side, and has Re(550) of: 100 nm<|Re(550)|<300 nm, and Rth(550) of 300 nm<Rth(550)<600 nm.

<8> The liquid crystal display device according to <1>, wherein the first retardation film has a slow axis vertical to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: −600 nm<Rth(550)<−300 nm, and wherein the second retardation film has a slow axis parallel to the absorption axis of the second polarizing plate located in the light outgoing side, and has Re(550) of 100 nm<|Re(550)|<300 nm, and Rth(550) of: −600 nm<Rth(550)<−300 nm.

<9> The liquid crystal display device according to <1>, wherein the first retardation film has a slow axis parallel to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: 300 nm<Rth(550)<600 nm, and wherein the second retardation film has a slow axis vertical to the absorption axis of the second polarizing plate located in the light outgoing side, and has Re(550) of: 100 nm<|Re(550)|<300 nm, and Rth(550) of 300 nm<Rth(550)<600 nm.

<10> The liquid crystal display device according to <1>, wherein the first retardation film has a slow axis parallel to the absorption axis of the second polarizing plate located in the light outgoing side, and has an in-plane retardation Re at a wavelength of 550 nm, Re(550), of: 100 nm<|Re(550)|<300 nm, and a retardation Rth in the thickness direction at a wavelength of 550 nm, Rth(550), of: 300 nm<Rth(550)<600 nm, and wherein the second retardation film has a slow axis parallel to the absorption axis of the second polarizing plate located in the light outgoing side, and has Re(550) of: 100 nm<|Re(550)|<300 nm, and Rth(550) of: −600 nm<Rth(550)<−300 nm.

<11> The liquid crystal display device according to <1>, wherein the liquid crystal display device is of a VA mode.

The VA cells vary upon production, and the retardation Rth in the thickness direction in each VA cell varies by approximately ±10 nm. Thus, the display performance of the final product varies depending on the VA cell used when the product is configured to compensate the light using the conventional optical compensation systems. However, according to the optical compensation system of the present invention, the display performance is not influenced by variation in the retardations Rth of the liquid crystal cells as the polarization state of light before the light enters the liquid crystal cell is changed to the state of the fixed point by the first retardation film, and then it is passed through the liquid crystal cell.

In the conventional optical compensation system, polarized lights consisting of a s-polarized light and a p-polarized light enters in oblique directions other than azimuth angles of the liquid crystal cell 0°, 90°, 180°, or 270°. As the reflectance at glass interface differs between the s-polarized light and the p-polarized light, multiple reflection occurs in a liquid crystal cell, thereby generating a plurality of lights having different balances between the s-polarized light and the p-polarized light. As a result, the polarization state of the light is changed. A plurality of lights in which each polarization state is changed are depolarized in total. These lights are not optically compensated after exiting from the liquid crystal cell, causing light leakage in black display.

On the other hand, in the optical compensation system of the present invention, the polarization state of the light before the light enters the liquid crystal cell is one of a p-polarized light and a s-polarized light, i.e. (S₁=+1 or −1, S₂=0, S₃=0). Thus, the polarization state of the light is not changed. As a result, the optical compensation can be suitably achieved, and light leakage in a liquid crystal panel is reduced compared to the conventional ones, thereby maintaining excellent display performance.

According to the present invention, the conventional problems can be solved, and a VA mode liquid crystal display device can be provided, which is not influenced by variation in the retardations Rth in the thickness direction of the liquid crystal cells, and can maintain excellent display performance free from light leakage, by changing the polarization state of light before the light enters the liquid crystal cell to the state of the fixed point, and then passing the light through the liquid crystal cell.

### BRIEF DESCRIPTION OF THE DRAWINGS

FIG. 1 is a Poincare sphere representation showing an example of a polarization state of light as passed through a liquid crystal display device in which a retardation film for VA mode is mounted.

FIG. 2A is a conceptual diagram showing an example of change of a polarization state of light as passed through a conventional liquid crystal display device.

FIG. 2B is a schematic view showing a layer configuration of the liquid crystal display device of FIG. 2A.

FIG. 3A is a conceptual diagram showing another example of change of a polarization state of light as passed through a conventional liquid crystal display device.

FIG. 3B is a schematic view showing a layer configuration of the liquid crystal display device of FIG. 3A.

FIG. 4A is a conceptual diagram showing still another example of change of a polarization state of light as passed through a conventional liquid crystal display device.

FIG. 4B is a schematic view showing a layer configuration of the liquid crystal display device of FIG. 4A.

FIG. 5A is a conceptual diagram showing an example of change of a polarization state of light as passed through a liquid crystal display device of the present invention.

FIG. 5B is another conceptual diagram showing an example of change of a polarization state of light as passed through a liquid crystal display device of the present invention.

FIG. 5C is a schematic view showing a layer configuration of the liquid crystal display device of FIGS. 5A and 5B.

FIGS. 6A to 6D are conceptual diagrams showing examples of changes of polarization states of lights as passed through liquid crystal display devices in Examples 1 to 4.

FIGS. 7A to 7D are conceptual diagrams showing examples of variation of the polarization states of lights as passed through liquid crystal display devices in Examples 5 to 8.

FIG. 8 is a view illustrating the definitions of s-polarized light and p-polarized light.

### DETAILED DESCRIPTION OF THE INVENTION

Hereinafter, the present invention will be explained in detail.

In the specification, “to” is used as a meaning of including the numerical values described before and after “to” as the minimum value and the maximum value, respectively.

In the specification, “the absorption axis of the first polarizing plate is vertical” means the absorption axis of the first polarizing plate is vertical to the absorption axis of the second polarizing plate located in a light outgoing side, and “the absorption axis of the first polarizing plate is parallel” means the absorption axis of the first polarizing plate is parallel to the absorption axis of the second polarizing plate located in the light outgoing side.

In the specification, “the slow axis of the first retardation film is vertical” means the slow axis of the first retardation film is vertical to the absorption axis of the second polarizing plate located in the light outgoing side, and “the slow axis of the first retardation film is parallel” means the slow axis of the first retardation film is parallel to the absorption axis of the second polarizing plate located in the light outgoing side.

In the specification, Re (λ) and Rth (λ) respectively represent in-plane retardation (nm) at a wavelength λ and retardation in a thickness direction (nm) at a wavelength λ. Re (λ) is measured in such a manner that light with a wavelength of λ nm is allowed to enter the film at the film normal direction and then the retardation value thereof is measured using a phase difference measuring apparatus KOBRA-21ADH or KOBRA-WR (manufactured by Oji Scientific Instruments). In the case where a film to be measured is represented by a uniaxial or biaxial index ellipsoid, the retardation value Rth (λ) is calculated in accordance with the following method.

Re (λ) is measured at six points in total by making light with a wavelength of λ nm enter from inclined directions set at different angles as far as 50° on each side at intervals of 10° with respect to the film normal direction, as a slow axis (judged by KOBRA-21ADH or KOBRA-WR) in the film plane serves as an inclined axis (rotational axis) (in the case where there is no slow axis, an arbitrary direction in the film plane serves as a rotational axis); then Rth (λ) is calculated by KOBRA-21ADH or KOBRA-WR, based upon the retardation values measured, an assumed value of the average refractive index, and a film thickness value that has been input.

As to the foregoing, in the case of a film wherein a slow axis in the film plane serves as a rotational axis and there is a direction in which the retardation value is zero at a certain inclined angle with respect to the film normal direction, the retardation value at an inclined angle greater than the certain inclined angle is given a minus sign, then Rth (λ) is calculated by KOBRA-21ADH or KOBRA-WR.

Additionally, with a slow axis serving as an inclined axis (rotational axis) (in the case where there is no slow axis, an arbitrary direction in the film plane serves as a rotational axis), the retardation values may be measured in relation to two arbitrary inclined directions, then Rth (λ) may be calculated from Equations (11) and (12) below, based upon those retardation values, an assumed value of the average refractive index, and a film thickness value that has been input.

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos {\{ {sin}^{- 1} ( \frac{sin ( - θ )}{nx} ) \}}^{2}} & Equation ( 11 ) \\ Rth = \{ ( nx + ny ) / 2 - nz \} \times d & Equation ( 12 )\end{matrix}$$

In Equations (11) and (12), Re (θ) denotes a retardation value in a direction inclined at an angle of θ to the normal direction; “nx” denotes the refractive index in the slow axis direction in the plane, “ny” denotes the refractive index in the direction perpendicular to “nx” in the plane, “nz” denotes the refractive index in the direction perpendicular to “nx” and “ny”; and “d” denotes a film thickness.

In the case where a film to be measured cannot be represented by a uniaxial or biaxial index ellipsoid, in other words where a film has no optical axis, Rth (λ) is calculated in accordance with the following method.

Re (λ) is measured at eleven points in total by making light with a wavelength of λ nm enter from inclined directions set at different angles ranging from −50° to +50° at intervals of 10° with respect to the film normal direction, as a slow axis (judged by KOBRA-21ADH or KOBRA-WR) in the film plane serves as an inclined axis (rotational axis); then Rth (λ) is calculated by KOBRA-21ADH or KOBRA-WR, based upon the retardation values measured, an assumed value of the average refractive index, and a film thickness value that has been input.

As to the measurement, the assumed value of the average refractive index may be selected from relevant values mentioned in Polymer Handbook (John Wiley & Sons, Inc) or in catalogues of optical films. If the value of the average refractive index of an optical film is unknown, it can be measured using an Abbe refractometer. The values of the average refractive indices of major optical films are shown below as examples: cellulose acylate (1.48), cycloolefin polymer (1.52), polycarbonate (1.59), polymethyl methacrylate (1.49), polystyrene (1.59). Upon input of the assumed value of the average refractive index and the film thickness value, KOBRA-21ADH or KOBRA-WR calculates nx, ny and nz. Based upon nx, ny and nz that have been calculated, the equation Nz=(nx−nz)/(nx−ny) can be calculated.

As to the sign of the Rth, positive (+) means that a phase difference is more than Re (λ), which is measured by making light with a wavelength of 550 nm enter from inclined directions set at an angle 20° with respect to the film normal direction, as a slow axis in the film plane serves as an inclined axis (rotational axis), and negative (−) means that a phase difference is less than Re (λ), which is measured by making light with a wavelength of 550 nm enter from inclined directions set at an angle 20° with respect to the film normal direction, as a slow axis in the film plane serves as an inclined axis (rotational axis). However, in the case of a sample having |Rth/Re| of 9 or more, a slow axis of the sample can be decided under the condition that the slow axis is inclined at an angle 40° with respect to the film normal direction, as a-fast axis in the film plane serves as an inclined axis (rotational axis) using a compensator of the polarizing plate by a polarization microscope equipped with a rotating stage. Positive (+) means the sample having a slow axis which is parallel to the film plane, and negative (−) means the sample having a slow axis which is in a film thickness direction.

In the specification, “substantially” with regard to an angle means that a margin of error relative to an accurate angle is less than ±5°, preferably ±4° or less, and more preferably ±3° or less; “substantially” with regard to retardation means that a difference is within ±5%. Moreover, in the specification, Re is not 0 means that Re is 5 nm or more. In the specification, the measurement wavelength of the refractive index means a wavelength of 550 nm, unless otherwise indicated. Further more, in the specification, “visible light” means light with a wavelength of 400 nm to 700 nm.

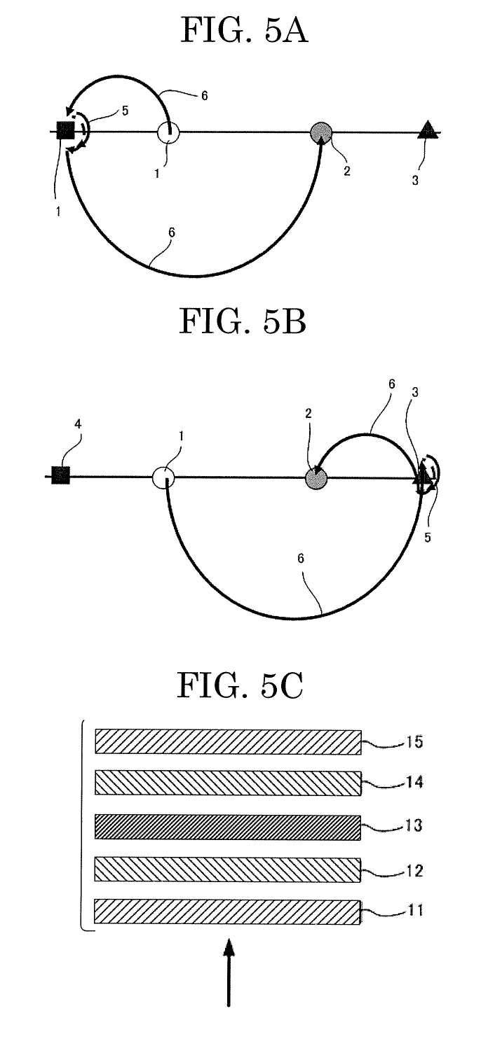

The liquid crystal display device of the present invention contains a first polarizing plate, a first retardation film, a liquid crystal cell, a second retardation film, and a second polarizing plate in this order from the light incident side (incident light is shown by arrow in FIG. 5), and further contains other layers as necessary.

The absorption axis of the first polarizing plate is vertical to the absorption axis of the second polarizing plate located in the light outgoing side. Thus, the display performance is of normally black as in the VA mode.

In the present invention, the relative relation between the absorption axis of the polarizing plate and the slow axis of the retardation film is not particularly limited as long as it is vertical or parallel. For example, when the entire liquid crystal display device is inclined at an angle of 90°, the absorption axis of the first polarizing plate is horizontal and the absorption axis of the second polarizing plate is vertical, and when the entire liquid crystal display device is inclined at an angle of 45°, the absorption axis of the first polarizing plate is at an angle of 45° and the absorption axis of the second polarizing plate is at an angle of 135°.

In the present invention, the polarization state of light before the light enters the liquid crystal cell is changed to the sate of the fixed point by the first retardation film, and then the light is passed through the liquid crystal cell, so as not to be influenced by variation in the retardations Rth in the thickness direction of the liquid crystal cells, and to maintain excellent display performance free from light leakage.

In the present invention, the light before entering the liquid crystal cell is optically compensated so as to have a polarization state of either s-polarized light or p-polarized light.

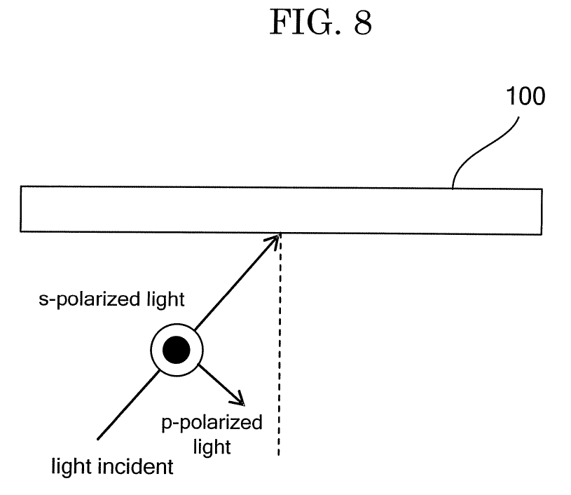

Here, the s-polarized light means a polarization state where an electric field of light oscillates in the normal direction relative to a surface of a substrate 100 of a liquid crystal cell, in which the light enters, as shown in FIG. 8. The p-polarized light means a state where a light electric field oscillates in a direction where a light progress direction is perpendicular to a direction of electric field oscillation of the s-polarized light (see FIG. 8).

In order to optically compensate the light to the polarization state of the s-polarized light, the transmitted light from the polarizing film is passed through the first retardation film 12 so as to change the polarization state thereof to the state as represented at a point (S1=1, S2=0, S3=0) on the Poincare sphere, before the light is allow to pass through the liquid crystal cell for further polarization.

In order to optically compensate the light to the polarization state of the p-polarized light, the transmitted light from the polarizing film is passed through the first retardation film 12 so as to change the polarization state thereof to the state as represented at a point (S1=−1, S2=0, S3=0) on the Poincare sphere, before the light is allow to pass through the liquid crystal cell for further polarization.

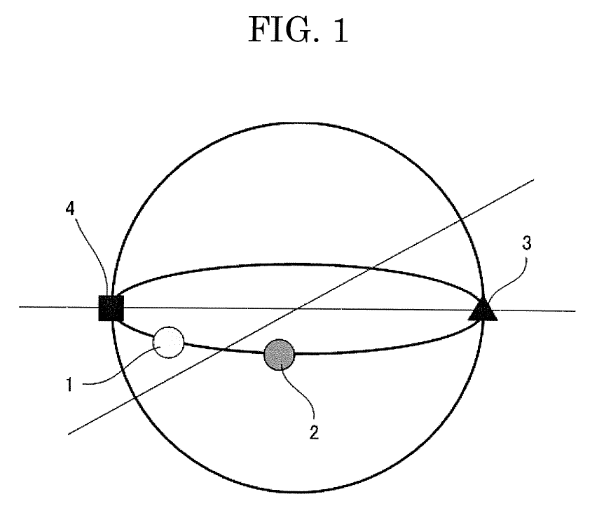

In the case of the VA liquid crystal cell, the points on the Poincare sphere (S1=+1, S2=0, S3=0) corresponds to the fixed points (3, 4 in FIG. 1).

The embodiment of the liquid crystal display device of the present invention is preferably one of the following first to eighth embodiments.

### First Embodiment

The first embodiment is that the first retardation film has the slow axis vertical to the absorption axis of the second polarizing plate located in the light outgoing side, and has an in-plane retardation Re at a wavelength of 550 nm, hereinafter referred to as Re(550), of: 100 nm<|Re(550)|<300 nm, preferably 125 nm<|Re(550)|<225 nm, and a retardation Rth in the thickness direction at a wavelength of 550 nm, hereinafter referred to as Rth(550), of: 300 nm<Rth(550)<600 nm, preferably 400 nm<Rth(550)<600 nm, and that the second retardation film has a slow axis parallel to the absorption axis of the second polarizing plate located in the light outgoing side, and has Re(550) of: 100 nm<|Re(550)|<300 nm, preferably 165 nm<|Re(550)|<265 nm, and Rth(550) of: −600 nm<Rth(550)<−300 nm, preferably −510 nm<Rth(550)<−310 nm.

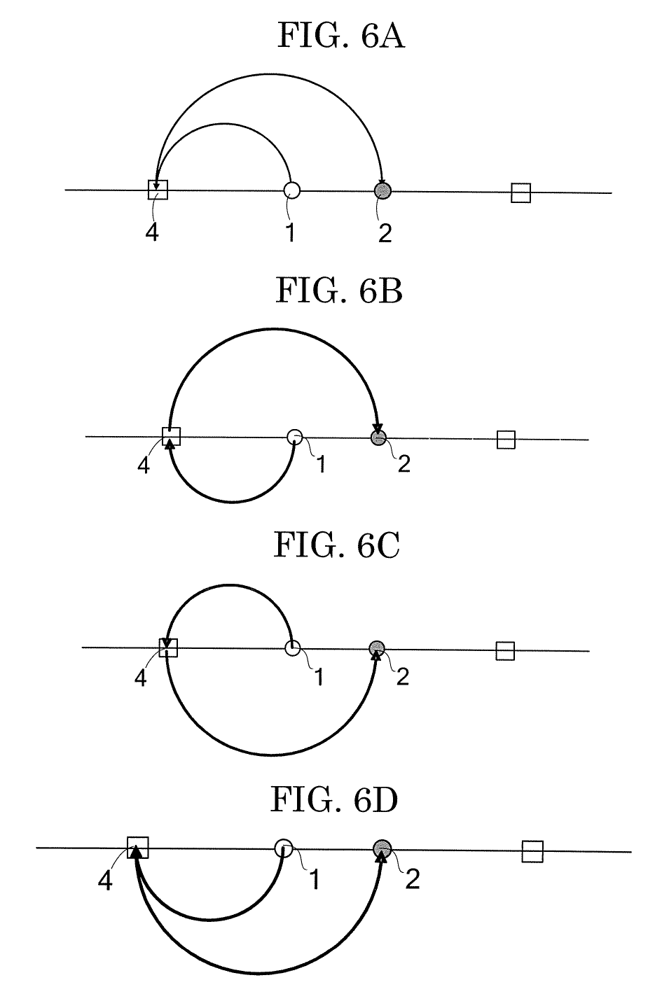

In the first embodiment, as shown in FIG. 6A, the polarization state of light is changed from a state of a start point 1 to a state of the fixed point 4 by the first retardation film, the transmitted light from the first retardation film is passed through the liquid crystal cell, and then the polarization state thereof is changed from the state of the fixed point 4 to a state of a goal point 2 by the second retardation film. As a result, even if the retardations Rth in the thickness direction of the liquid crystal cells vary, the liquid crystal display device is not influenced by the variation, thereby maintaining excellent display performance.

Here, the start point 1 is decided by representing on the Poincare sphere the polarization state of the light passed through the polarizing plate located in the light incident side, when the polarizing plate is seen from an azimuth angle of 45° and a polar angle of 60° so as to easily observe the amount of light leakage in an oblique direction.

### Second Embodiment

The second embodiment is that the first retardation film has the slow axis parallel to the absorption axis of the second polarizing plate located in the light outgoing side, and has Re(550) of: 100 nm<|Re(550)|<300 nm, preferably 125 nm<|Re(550)|<225 nm, and Rth(550) of −600 nm<Rth(550)<−300 nm, preferably −600 nm<Rth(550)<−400 nm and that the second retardation film has a slow axis parallel to the absorption axis of the second polarizing plate located in the light outgoing side, and has Re(550) of: 100 nm<|Re(550)|<300 nm, preferably 165 nm<|Re(550)|<265 nm, and Rth(550) of −600 nm<Rth(550)<−300 nm, preferably −510 nm<Rth(550)<−310 nm.

In the second embodiment, as shown in FIG. 6B, the polarization state of light is changed from a state of the start point 1 to a state of the fixed point 4 by the first retardation film, the transmitted light from the first retardation film is passed through the liquid crystal cell, and then the polarization state thereof is changed from the state of the fixed point 4 to a state of the goal point 2 by the second retardation film. As a result, even if the retardations Rth in the thickness direction of the liquid crystal cells vary, the liquid crystal display device is not influenced by the variation, thereby maintaining excellent display performance.

### Third Embodiment

The third embodiment is that the first retardation film has the slow axis vertical to the absorption axis of the second polarizing plate located in the light outgoing side, and has Re (550) of: 100 nm<|Re(550)|<300 nm, preferably 125 nm <|Re(550)|<225 nm, and Rth(550) of: 300 nm<Rth(550)<600 nm, preferably 400 nm<Rth(550)<600 nm and that the second retardation film has a slow axis vertical to the absorption axis of the second polarizing plate located in the light outgoing side, and has Re(550) of: 100 nm<|Re(550)|<300 nm, preferably 165 nm<|Re(550)|<265 nm, and Rth(550) of 300 nm<Rth(550)<600 nm, preferably 310 nm<Rth(550)<510 nm.

In the third embodiment, as shown in FIG. 6C, the polarization state of light is changed from a state of the start point 1 to a state of the fixed point 4 by the first retardation film, the transmitted light from the first retardation film is passed through the liquid crystal cell, and then the polarization state thereof is changed from the state of the fixed point 4 to a state of the goal point 2 by the second retardation film. As a result, even if the retardations Rth in the thickness direction of the liquid crystal cells vary, the liquid crystal display device is not influenced by the variation, thereby maintaining excellent display performance.

### Fourth Embodiment

The fourth embodiment is that the first retardation film has the slow axis parallel to the absorption axis of the second polarizing plate located in the light outgoing side, and has Re(550) of: 100 nm<|Re(550)|<300 nm, preferably 125 nm <|Re(550)|<225 nm, and Rth(550) of: −600 nm<Rth(550)<−300 nm, preferably −600 nm<Rth(550)<−400 nm and that the second retardation film has a slow axis vertical to the absorption axis of the second polarizing plate located in the light outgoing side, and has Re(550) of: 100 nm<|Re(550)|<300 nm, preferably 165 nm<|Re(550)|<265 nm, and Rth(550) of: 300 nm<Rth(550)<600 nm, preferably 310 nm<Rth(550)<510 nm.

In the fourth embodiment, as shown in FIG. 6D, the polarization state of light is changed from a state of the start point 1 to a state of the fixed point 4 by the first retardation film, the transmitted light from the first retardation film is passed through the liquid crystal cell, and then the polarization state thereof is changed from the state of the fixed point 4 to a state of the goal point 2 by the second retardation film. As a result, even if the retardations Rth in the thickness direction of the liquid crystal cells vary, the liquid crystal display device is not influenced by the variation, thereby maintaining excellent display performance.

### Fifth Embodiment

The fifth embodiment is that the first retardation film has the slow axis vertical to the absorption axis of the second polarizing plate located in the light outgoing side, and has Re(550) of: 100 nm<|Re(550)|<300 nm, preferably 165 nm<|Re(550)|<265 nm, and Rth(550) of −600 nm<Rth(550)<−300 nm, preferably −510 nm<Rth(550)<−310 nm and that the second retardation film has a slow axis vertical to the absorption axis of the second polarizing plate located in the light outgoing side, and has Re(550) of: 100 nm<|Re(550)|<300 nm, preferably 125 nm<|Re(550)|<225 nm, and Rth(550) of: 300 nm<Rth(550)<600 nm, preferably 400 nm<Rth(550)<600 nm.

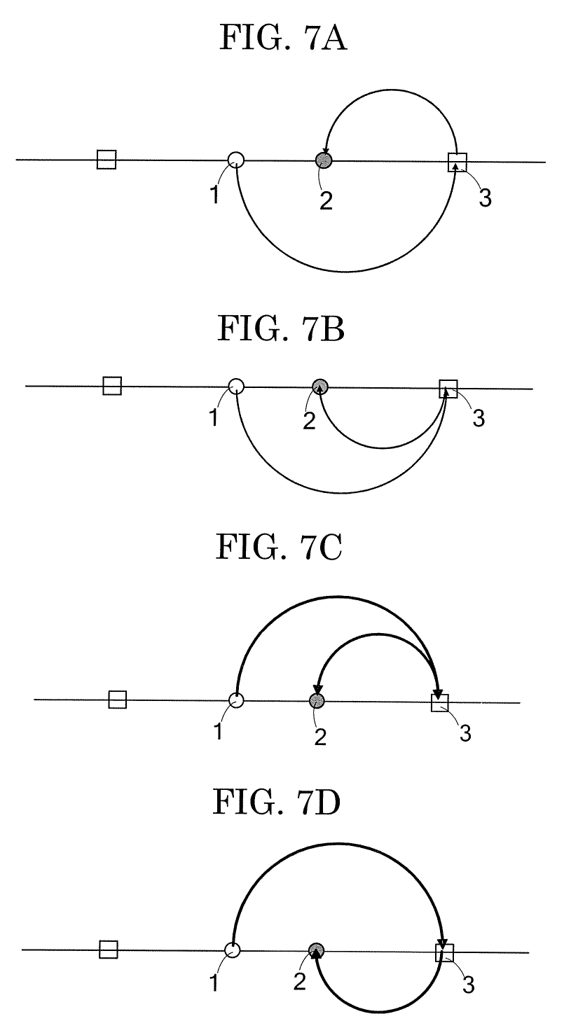

In the fifth embodiment, as shown in FIG. 7A, the polarization state of light is changed from a state of the start point 1 to a state of the fixed point 3 by the first retardation film, the transmitted light from the first retardation film is passed through the liquid crystal cell, and then the polarization state thereof is changed from the state of the fixed point 3 to a state of the goal point 2 by the second retardation film. As a result, even if the retardations Rth in the thickness direction of the liquid crystal cells vary, the liquid crystal display device is not influenced by the variation, thereby maintaining excellent display performance.

### Sixth Embodiment

The sixth embodiment is that the first retardation film has the slow axis vertical to the absorption axis of the second polarizing plate located in the light outgoing side, and has Re(550) of: 100 nm<|Re(550)|<300 nm, preferably 165 nm <|Re(550)|<265 nm, and Rth(550) of −600 nm<Rth(550)<−300 nm, preferably −510 nm<Rth(550)<−310 nm and that the second retardation film has a slow axis parallel to the absorption axis of the second polarizing plate located in the light outgoing side, and has Re(550) of: 100 nm<|Re(550)|<300 nm, preferably 125 nm <|Re(550)|<225 nm, and Rth(550) of: −600 nm<Rth(550)<−300 nm, preferably −600 nm<Rth(550)<−400 nm.

In the sixth embodiment, as shown in FIG. 7B, the polarization state of light is changed from a state of the start point 1 to a state of the fixed point 3 by the first retardation film, the transmitted light from the first retardation film is passed through the liquid crystal cell, and then the polarization state thereof is changed from the state of the fixed point 3 to a state of the goal point 2 by the second retardation film. As a result, even if the retardations Rth in the thickness direction of the liquid crystal cells vary, the liquid crystal display device is not influenced by the variation, thereby maintaining excellent display performance.

### Seventh Embodiment

The seventh embodiment is that the first retardation film has the slow axis parallel to the absorption axis of the second polarizing plate located in the light outgoing side, and has Re(550) of: 100 nm<|Re(550)|<300 nm, preferably 165 nm<|Re(550)|<265 nm, and Rth(550) of: 300 nm<Rth(550)<600 nm, preferably 310 nm<Rth(550)<510 nm and that the second retardation film has a slow axis vertical to the absorption axis of the second polarizing plate located in the light outgoing side, and has Re(550) of: 100 nm<|Re(550)|<300 nm, preferably 125 nm<|Re(550)|<225 nm, and Rth(550) of 300 nm<Rth(550)<600 nm, preferably 400 nm<Rth(550)<600 nm.

In the seventh embodiment, as shown in FIG. 7C, the polarization state of light is changed from a state of the start point 1 to a state of the fixed point 3 by the first retardation film, the transmitted light from the first retardation film is passed through the liquid crystal cell, and then the polarization state thereof is changed from the state of the fixed point 3 to a state of the goal point 2 by the second retardation film. As a result, even if the retardations Rth in the thickness direction of the liquid crystal cells vary, the liquid crystal display device is not influenced by the variation, thereby maintaining excellent display performance.

### Eighth Embodiment

The eighth embodiment is that the first retardation film has a slow axis of parallel to the absorption axis of the second polarizing plate located in the light outgoing side, and has Re(550) of: 100 nm<|Re(550)|<300 nm, preferably 165 nm <|Re(550)|<265 nm, and Rth (550) of: 300 nm<Rth(550)<600 nm, preferably 310 nm<Rth(550)<510 nm and that the second retardation film has a slow axis parallel to the absorption axis of the second polarizing plate located in the light outgoing side, and has Re(550) of: 100 nm<|Re(550)|<300 nm, preferably 125 nm <|Re(550)|<225nm, and Rth(550) of: −600 nm<Rth(550)<−300 nm, preferably −600 nm<Rth(550)<−400 nm.

In the eighth embodiment, as shown in FIG. 7D, the polarization state of light is changed from a state of the start point 1 to a state of the fixed point 3 by the first retardation film, the transmitted light from the first retardation film is passed through the liquid crystal cell, and then the polarization state thereof is changed from the state of the fixed point 3 to a state of the goal point 2 by the second retardation film. As a result, even if the retardations Rth in the thickness direction of the liquid crystal cells vary, the liquid crystal display device is not influenced by the variation, thereby maintaining excellent display performance.

In the liquid crystal display device of the present invention, the material, shape, size, structure and production method of each of the first polarizing plate, the first retardation film, the liquid crystal cell, the second retardation film and the second polarizing plate are not particularly limited and may be appropriately selected depending on the intended purpose.

### —Liquid Crystal Cell—

The liquid crystal cell is preferably a VA mode liquid crystal cell.

The Rth of the liquid crystal cell is preferably 200 nm to 400 nm.

In the cell having less variation of Rth can suppress the variation of the display performance. In the case where the same retardation films are used for the production of the liquid crystal display devices, for example, the variation of Rth (individual variability) in two cells is as small as possible, so that the liquid crystal display devices having excellent display performance can be obtained at any time through out the mass production. However, practically, as production variation, for example, Rth varies in a range of approximately 300 nm±30 nm.

### —First and Second Polarizing Plates—

In the present invention, a polarizing plate consisting of a polarizing film and a pair of protective film sandwiching the polarizing film can be used. For example, the polarizing plate is obtained by dyeing a polarizing film formed of a polyvinyl alcohol film and the like with iodine, stretching, and laminating the both surfaces of the film with protective films. The polarizing plate is disposed on both surfaces of the liquid crystal cell. Preferably, a pair of polarizing plates each consisting of a polarizing film and a pair of protective film sandwiching the polarizing film are arranged so as to sandwich the liquid crystal cell.

The polarizing plate for use in the present invention preferably has the optical properties and durability (short-term or long term storage stability) equal to or more than that of a commercially available super high contrast product, such as HLC2-5618 manufactured by SANRITZ CORPORATION. Specifically, the polarizing plate preferably has a visible light transmittance of 42.5% or more, and a polarization degree is expressed by the following formula:

{(Tp−Tc)/(Tp+Tc)}½≧0.9995

where Tp represents parallel transmittance and Tc represents cross transmittance.

In addition, it is preferred that the polarization plate have the variation of light transmittance before and after the polarizing plate is left for stand in an atmosphere at 60° C. and 90RH % for 500 hours and in a dry atmosphere at 80° C. for 500 hours is preferably 3% or less, and more preferably 1% or less, on the basis of the absolute value. The variation of the polarization degree is preferably 1% or less, and more preferably 0.1% or less, on the basis of the absolute value.

### —First and Second Retardation Films—

The material of the retardation film used in the present invention is not limited, as long as the retardation film satisfies the optical properties described above. The optical properties are achieved by a single film or a laminated film. Moreover, the retardation film may also serve as the protective film, or be bonded to the protective film. As the retardation film a transparent support can be used. In this case, the transparent support is preferably optically uniaxial or optically biaxial. In the case of the optical uniaxial support, the retardation film may be optically positive (the refractive index in the direction of the optical axis is larger than that in the direction vertical to the optical axis) or optically negative (the refractive index in the direction of the optical axis is smaller than that in the direction vertical to the optical axis). In the case of the optical biaxial support, the refractive index nx, ny and nz are all different values (nx≠ny≠nz). The transparent support has an in-plane retardation (Re) at a wavelength of 550 nm of preferably 10 nm to 1,000 nm, more preferably 15 nm to 800 nm, and still more preferably 20 nm to 400 nm. The transparent support has a retardation Rth in the thickness direction at a wavelength of 550 nm of preferably 10 nm to 1,000 nm, more preferably 100 nm to 800 nm, and still more preferably 200 nm to 700 nm.

The material for forming the retardation film depends on whether it is constructed as an optically isotropic support or an optically anisotropic support.

Generally, glass or cellulose ester is used for the optically isotropic support, and a synthetic polymer such as polycarbonate, polysulfone, polyethersulfone, polyacrylate, polymethacrylate, norbornene resin, or the like is used for the optically anisotropic support. Alternatively, an optically anisotropic cellulose ester film, i.e., one having high retardation can be produced by (1) use of a retardation increasing agent, (2) decreasing of acetylation degree of cellulose acetate, and (3) a cool-dissolution method, as described in EP0911656A2. The transparent support formed from a polymer film is preferably formed by a solvent cast method. As the polymer film, a cellulose acylate film is preferably used. When a retardation film is formed by laminating a plurality of films, polymers having the same compositions are preferably used in terms of optical uniformity.

A polymer film is preferably stretched to obtain an optically anisotropic transparent support. An optically uniaxial support is typically produced by uniaxially-stretching or biaxially-stretching the polymer film. An optical biaxial support is preferably produced by unbalanced biaxially-stretching the polymer film. The unbalanced biaxial stretching is performed in such a manner that a polymer film is stretched in any direction at a certain percentage, for example, 3% to 100%, preferably 5% to 30%, and further stretched in a direction vertical to the certain direction at that percentage or more, for example, 6% to 200%, preferably 10% to 90%. The stretching treatment in two directions may be performed at the same time. The stretching direction, or in the case of the unbalanced biaxial stretching a direction of high stretch percentage, is substantially the same as that of the slow axis in the film plane which has been stretched. The angle formed between the stretching direction and the slow axis is preferably less than 10°, more preferably less than 5°, and still more preferably less than 3°.

The thickness of the retardation film is preferably as thin as possible within a range where the effect of the present invention is obtained. It is more preferably 10 μm to 500 μm, and still more preferably 40 μm to 200 μm. The transparent support may be surface treated so as to enhance adhesion between the transparent support and a layer disposed thereon. Examples of surface treatment processes include a glow discharge process, corona discharge process, LW irradiation process and flame process. An UV absorbent may be added to the transparent support. On the transparent support, an adhesion layer (undercoat layer) may be disposed. The adhesion layer include those disclosed in Japanese Patent Application Laid-Open (JP-A) No. 07-333433. The adhesion layer has a thickness of preferably 0.1 μm to 2 μm, and more preferably 0.2 μm to 1 μm. The slow axis of the retardation film is preferably vertical or parallel to the absorption axis of the polarizing plate.

The liquid crystal display device of the present invention is particularly suitably used in a VA mode liquid crystal display device, as it is not influenced by variation in the retardations Rth in the thickness direction of the liquid crystal cells, and can maintain excellent display performance.

### EXAMPLES

Hereinafter, Examples of the present invention will be described, which however shall not be construed as limiting the scope of the present invention. All parts are by mass unless indicated otherwise.

### Production Example 1

### Production of Retardation Film

Two retardation films, which respectively had Re of about 180 nm and Rth of about 510 nm, and Re of about 210 nm and Rth of about 420 nm, were produced.

A cellulose acylate solution was prepared by mixing components in the ratio as described below. The cellulose acylate solution was flow casted by a band-casting machine, and then the obtained web was separated from the band. Next, the web was stretched by 20% in TD direction at 140° C., and dried to produce a cellulose acylate film having a thickness of 55 μm.

### —Cellulose Acylate Solution—

| | |
|---|---|
| Cellulose acylate having a degree of substitution with an acetyl group of 2.81 | 100 parts |
| A liquid crystal compound F-1 expressed by the following Structural Formula | 2 parts |
| 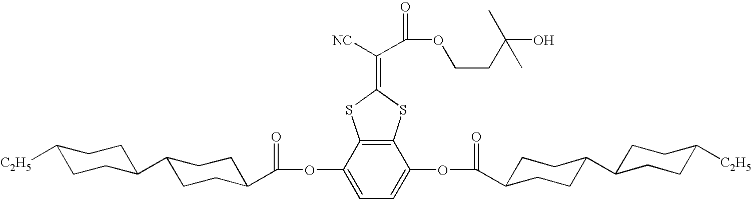 | |
| Liquid Crystal Compound F-1 | |
| Liquid crystal compound F-2 expressed by the following Structural Formula | 6 parts |
| 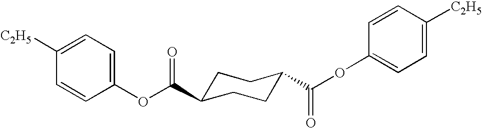 | |
| Liquid Crystal Compound F-2 | |
| Triphenyl phosphate | 3 parts |
| Diphenyl phosphate (plasticizer) | 2 parts |
| Methylene chloride | 418 parts |
| Methanol | 62 parts |

Next, the stretch percentage of the obtained film was changed to produce two films in a thickness of 50 μm respectively having Re of 60 nm and Rth of 170 nm, and Re of 70 nm and Rth of 140 nm. Three of each film are laminated so as to produce Retardation Film in a thickness of 150 μm a having Re of about 180 nm and Rth of about 510 nm, and Retardation Film b in a thickness of 150 μm having Re of about 210 nm and Rth of about 420 nm.

### Production Example 2

### Production of Retardation Film

A retardation film having Re of about 83 nm and Rth of about −161 nm was produced in the same manner as disclosed in Example 1 of JP-A No. 2007-169599.

These retardation films were uniaxially-stretched so as to produce two films in a thickness of 75 μm having Re of 70 nm and Rth of −140 nm, and Re of 60 nm and Rth of −170 nm, respectively. Three of each film are laminated so as to produce Retardation Film c in a thickness of 225 μm having Re of about 210 nm and Rth of about −420 nm, and Retardation Film d in a thickness of 225 μm having Re of about 180 nm and Rth of about −510 nm.

### Production Example 3

### Production of First and Second Polarizing Plate

A polyvinyl alcohol (PVA) film having a thickness of 80 μm was immersed in an aqueous iodine solution containing 0.05% by mass of iodine at 30° C. for 60 seconds so as to be dyed, longitudinally stretched 5 times while immersed in an aqueous boric acid solution containing 4% by mass of boric acid for 60 seconds, and then dried at 50° C. for 4 minutes, thereby obtaining a polarization film having a thickness of 20 μm.

On a surface of the obtained Retardation Film a an isocyanate adhesive was coated, and on a surface a TAC film (FUJITAC TF80UL manufactured by FUJIFILM Corporation) a PVA adhesive was coated, between which the produced polarization film was sandwiched, and formed into a laminate by wet lamination while excess adhesive was pushed out by a pressure roller. Then, the laminate was dried by heating to produce a first polarizing plate. An adhesion layer had a thickness of 0.4 μm.

On a surface of the obtained Retardation Film b an isocyanate adhesive was coated, and on a surface of a TAC film (FUJITAC TF80UL manufactured by FUJIFILM Corporation) a PVA adhesive was coated, between which the produced polarization film was sandwiched, and formed into a laminate by wet lamination while excess adhesive was pushed out by a pressure roller. Then, the laminate was dried by heating to produce a second polarizing plate. An adhesion layer had a thickness of 0.4 μm.

### Production Example 4

### Production of Liquid Crystal Cell

A liquid crystal cell in which an ellipsoidal polarizing plate was removed from a commercially available VA liquid crystal display device (KDL-40J5000 manufactured by Sony Corporation) was used. The VA liquid crystal cell had Rth of 303 nm.

### Examples 1 to 8

The obtained four Retardation Films a-d, the first and second polarizing plates, and the liquid crystal cell were combined as shown in Table 1-1 and FIG. 5, so as to produce each of liquid crystal display devices of Examples 1 to 8.

### Comparative Example 1

A liquid crystal display device of Comparative Example 1 was produced in the same manner as disclosed in Example 1 of Japanese Patent (JP-B) No. 3330574.

### Comparative Example 2

A liquid crystal display device of Comparative Example 2 was produced in the same manner as disclosed in Example 1 of Japanese Patent Application Laid-Open (JP-A) No. 2003-344856.

The Re and Rth of each of the retardation films in the produced liquid crystal display devices of Examples 1 to 8 and Comparative Examples 1 to 2 were measured as follows. The results are shown in Tables 1-1 and 1-2.

<Measurement of Re and Rth of Retardation film>

The in-plane retardation Re at a wavelength of 550 nm and retardation Rth in the thickness direction at a wavelength of 550 nm were calculated by using KOBRA-21ADH or KOBRA-WR (manufactured by Oji Scientific Instruments).

TABLE 1-1

| | | First | First | Liquid | Second | Second | |
|---|---|---|---|---|---|---|---|
| | | polarizing | retardation | crystal | retardation | polarizing | |
| | | plate | film | cell | film | plate | Drawings |
| Ex. 1 | Type of retardation film | — | a | — | c | — | FIG. 6A |
| | Re (nm) | — | 173 | 0 | 213 | — | |
| | Rth (nm) | — | 504 | −300 | −411 | — | |
| | Axis angle (degree) | 90 | 90 | — | 0 | 0 | |
| | Nz | — | 3.4 | — | −1.4 | — | |
| Ex. 2 | Type of retardation film | — | d | — | c | — | FIG. 6B |
| | Re (nm) | — | 173 | 0 | 213 | — | |
| | Rth (nm) | — | −508 | −300 | −411 | — | |
| | Axis angle (degree) | 90 | 0 | — | 0 | 0 | |
| | Nz | — | −2.4 | — | −1.4 | — | |
| Ex. 3 | Type of retardation film | — | a | — | b | — | FIG. 6C |
| | Re (nm) | — | 173 | 0 | 214 | — | |
| | Rth (nm) | — | 504 | −300 | 409 | — | |
| | Axis angle (degree) | 90 | 90 | — | 90 | 0 | |
| | Nz | — | 3.4 | — | 2.4 | — | |
| Ex. 4 | Type of retardation film | — | d | — | b | — | FIG. 6D |
| | Re (nm) | — | 173 | 0 | 214 | — | |
| | Rth (nm) | — | −508 | −300 | 409 | — | |
| | Axis angle (degree) | 90 | 0 | — | 90 | 0 | |
| | Nz | — | −2.4 | — | 2.4 | — | |
| Ex. 5 | Type of retardation film | — | c | — | a | — | FIG. 7E |
| | Re (nm) | — | 213 | 0 | 174 | — | |
| | Rth (nm) | — | −411 | −300 | 504 | — | |
| | Axis angle (degree) | 90 | 90 | — | 90 | 0 | |
| | Nz | — | −1.4 | — | 3.4 | — | |
| Ex. 6 | Type of retardation film | — | c | — | d | — | FIG. 7F |
| | Re (nm) | — | 213 | 0 | 173 | — | |
| | Rth (nm) | — | −411 | −300 | −508 | — | |
| | Axis angle (degree) | 90 | 90 | — | 0 | 0 | |
| | Nz | — | −1.4 | — | −2.4 | — | |
| Ex. 7 | Type of retardation film | — | b | — | a | — | FIG. 7G |
| | Re (nm) | — | 214 | 0 | 174 | — | |
| | Rth (nm) | — | 409 | −300 | 504 | — | |
| | Axis angle (degree) | 90 | 0 | — | 90 | 0 | |
| | Nz | — | 2.4 | — | 3.4 | — | |
| Ex. 8 | Type of retardation film | — | b | — | d | — | FIG. 7H |
| | Re (nm) | — | 214 | 0 | 173 | — | |
| | Rth (nm) | — | 409 | −300 | −508 | — | |
| | Axis angle (degree) | 90 | 0 | — | 0 | 0 | |
| | Nz | — | 2.4 | — | −2.4 | — | |

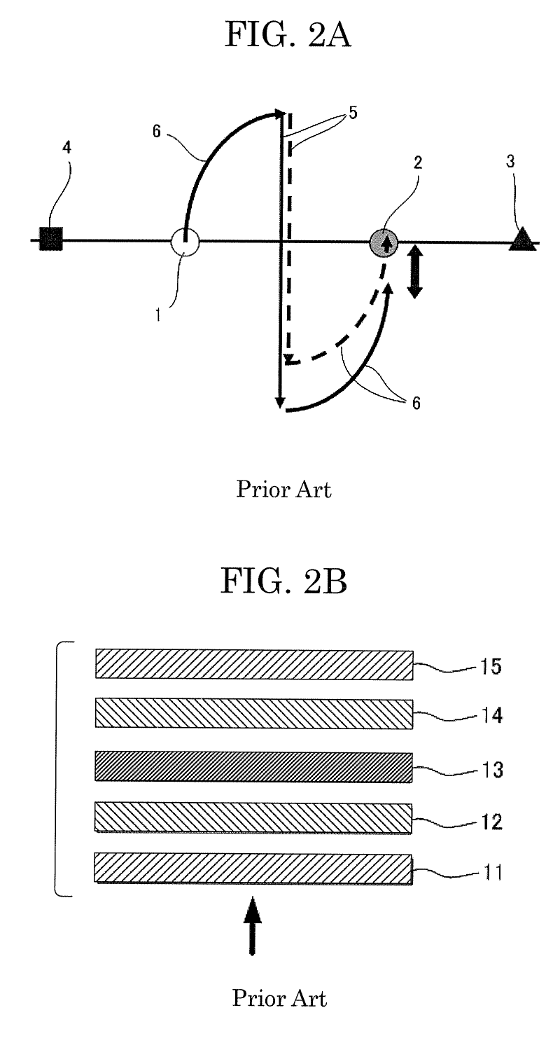

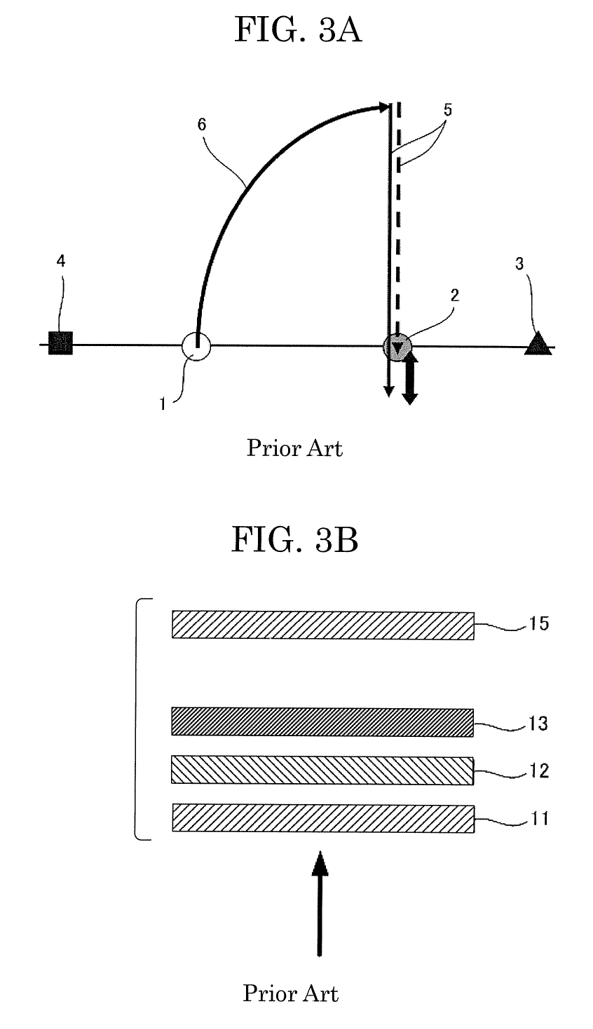

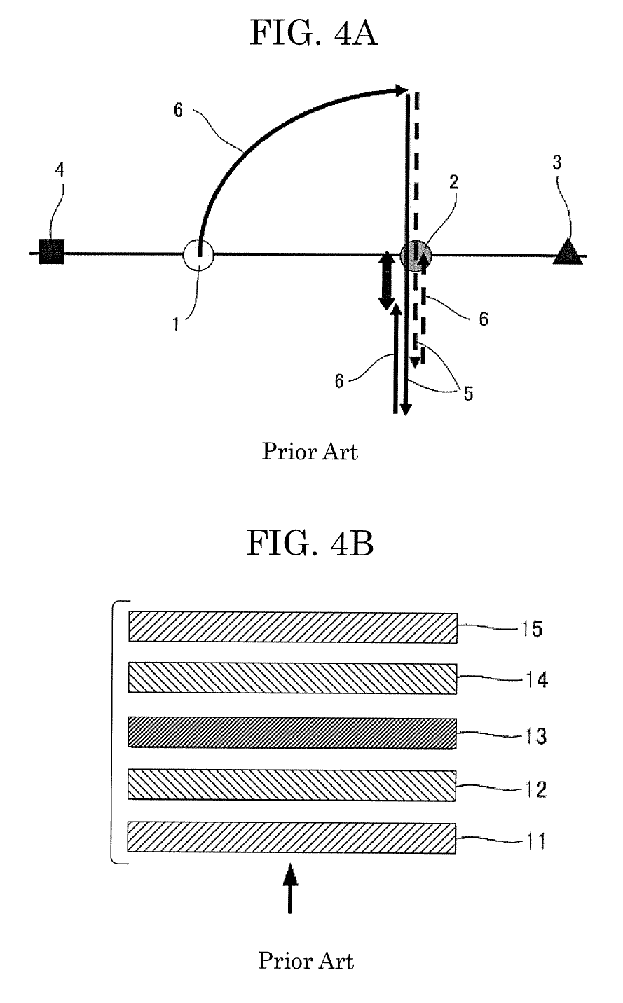

TABLE 1-2

| | | First | First | Liquid | Second | Second | |
|---|---|---|---|---|---|---|---|
| | | polarizing | retardation | crystal | retardation | polarizing | |
| | | plate | film | cell | film | plate | Drawings |
| Comp. | Re (nm) | — | 50 | 0 | 50 | — | FIG. 2 |
| Ex. 1 | Rth (nm) | — | 120 | −300 | 120 | — | |
| | Axis angle (degree) | 90 | 0 | — | 90 | 0 | |
| Comp. | Re (nm) | — | 55 | 0 | 0 | — | FIG. 4 |
| Ex. 2 | Rth (nm) | — | 200 | −300 | 50 | — | |
| | Axis angle (degree) | 90 | 0 | — | — | 0 | |

Next, the polarization state of light before the light enters the liquid crystal cell, obliquely leaked light, and color shift in the oblique direction of the each produced liquid crystal display devices were evaluated. The results are shown in Table 2.

### <Measurement of Polarization State of Light Before Light Enters Liquid Crystal Cell>

On a light source, the first polarizing plate adhered with the first retardation film which had not been adhered to the liquid crystal cell was placed, in which the surface of the first retardation film faced upward. The transmitted light from the first retardation film was passed through the another polarizing plate (POLAX-15 manufactured by luceo Co., Ltd.) and then detected by SR-3 (manufactured by TOPCON TECHNOHOUSE CORPORATION). The polarizing plate manufactured by luceo Co., Ltd. rotated an absorption axis thereof at an angle A of 0° to 360°, in the in-plane vertical to the observation direction of SR-3. The transmitted light was detected by SR-3 as the absorption axis rotated from 0° to 360° at intervals of 10°. The detection signal S₀ₒᵤₜ(λ) was expressed by the following equation:

$${S}_{0 out} ( λ ) = \frac{{S}_{0 in} ( λ )}{2} [ 1 + {S}_{1} ( λ ) cos ( 2 A ) + {S}_{2} ( λ ) sin ( 2 A ) ]$$

where S₀ᵢₙ(λ) represents an amount of incident light, S₁(λ) and S₂(λ) each represents polarization, and these are Stokes parameters. The detection signal is substituted into the equation so as to obtain S₁(λ) and S₂(λ). A represents an angle of the absorption axis. Then, S₃(λ) is obtained by the following equation.

S₃(λ)=√1−S₁²−S₂²

### <Obliquely Leaked Light>

By using two VA cells each having Rth of −300 nm and Rth of −330 nm, a luminance at a polar angle of 60° and an azimuth angle of 45° and that at a polar angle of 0° and an azimuth angle of 0° were measured, and the luminance at a polar angle of 60° and an azimuth angle of 45°/the luminance at a polar angle of 0° and an azimuth angle of 0° determined as obliquely leaked light. Then, the obliquely leaked light was evaluated on the basis of the following evaluation criteria.

### Evaluation Criteria:

A: Light leakage hardly occurred and compensation was excellent.

B: A little light leakage occurred, but compensation was substantially excellent.

C: Light leakage recognizably occurred and compensation was not achieved.

D: Light leakage outstandingly occurred and compensation was not achieved.

### <Color Shift in the Oblique Direction >

By using two VA cells each having Rth of −300 nm and Rth of −330 nm, a distance Δu′v′ of chromaticity between a chromaticity u′v′ at a polar angle of 60° and an azimuth angle of 45° and a chromaticity u′v′ at a polar angle of 0° and an azimuth angle of 0° was obtained to evaluate color shift in the oblique direction on the basis of the following evaluation criteria. The chromaticity u′ v′ is one of the colorimetric systems determined by International Commission on Illumination (CIE).

### Evaluation Criteria:

A: Little color shift occurred and was hardly noticeable.

B: A little color shift occurred but display performance was excellent.

C: Color shift outstandingly occurred and display performance was poor.

D: Color shift was hardly compensated.

TABLE 2

| | | VA cell Rth = | | | |
|---|---|---|---|---|---|
| | | −300 nm | | | |
| | Polarization state | | Color shift | VA cell Rth = −330 nm | |
| | of light before the | Obliquely | in the | | Color shift in |
| | light enters a | leaked | oblique | Obliquely | the oblique |
| | liquid crystal cell | light | direction | leaked light | direction |
| Example 1 | (1, 0, 0) | A | B | B | B |
| Example 2 | (1, 0, 0) | A | A | B | A |
| Example 3 | (1, 0, 0) | A | A | B | A |
| Example 4 | (1, 0, 0) | A | B | B | B |
| Example 5 | (−1, 0, 0) | A | A | B | A |
| Example 6 | (−1, 0, 0) | A | B | B | B |
| Example 7 | (−1, 0, 0) | A | B | B | B |
| Example 8 | (−1, 0, 0) | A | A | B | A |
| Comparative | (0.11, −0.79, −0.61) | B | A | D | C |
| Example 1 | | | | | |
| Comparative | (0, −0.52, −0.86) | B | B | D | D |
| Example 2 | | | | | |

As shown in Table 2, the polarization state of the light before the light enters the liquid crystal cell in each of Examples 1 to 8 was represented by (S₁=±1, S₂=0, S₃=0), where the polarization state was changed to the sate of the fixed point for the VA cell. Thus, both VA cells each having Rth of −300 nm and Rth of −330 nm were appropriately optically compensated and maintained the state of less color shift in the oblique direction. Moreover, the polarization state of the light before the light enters the liquid crystal cell in each of Examples 1 to 8 was represented by (S₁=±1, S₂=0, S₃=0) only in the s-polarized light, and (S₁=−1, S₂=0, S₃=0) only in the p-polarized light, causing less depolarization in the liquid crystal cell and less obliquely leaked light. Thus, the polarization state of the light before the light enters the liquid crystal cell in Examples 1 to 8 maintained in the excellent state.

On the other hand, the polarization state of the light before the light enters the liquid crystal cell in each of Comparative Examples 1 and 2 was not represented by (S₁=+1, S₂=0, S₃=0). Thus, when Rth of the VA cell was just shifted by approximately 30 nm, black tone in an oblique direction largely shifted. Additionally, the evaluation of the obliquely leaked light in each of Comparative Examples 1 and 2 was inferior to those in Examples 1 to 8.

The liquid crystal display device of the present invention is particularly suitably used in a VA mode liquid crystal display device, as it is not influenced by variation in the retardations Rth in the thickness direction of the liquid crystal cells, and can maintain excellent display performance.

What is claimed is:

1. A liquid crystal display device comprising:
a first polarizing plate;
a first retardation film;
a liquid crystal cell;
a second retardation film; and
a second polarizing plate in this order from a light incident side,
wherein an absorption axis of the first polarizing plate and an absorption axis of the second polarizing plate are orthogonal to each other, and
wherein the first retardation film is configured to change a polarization state of light to a state of a fixed point before the light enters the liquid crystal cell so as to allow the liquid crystal cell transmit the light having the polarization state of the fixed point.

2. The liquid crystal display device according to claim 1, wherein the polarization state of light before the light enters the liquid crystal cell is one of a p-polarized light and a s-polarized light.

3. The liquid crystal display device according to claim 1, wherein the first retardation film has a slow axis vertical to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
300 nm<Rth(550)<600 nm, and
wherein the second retardation film has a slow axis parallel to the absorption axis of the second polarizing plate located in the light outgoing side, and has Re(550)
100 nm<|Re(550)|<300 nm,
and Rth(550) of:
−600 nm<Rth(550)<−300 nm.

4. The liquid crystal display device according to claim 1, wherein the first retardation film has a slow axis parallel to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
−600 nm<Rth(550)<−300 nm, and
wherein the second retardation film has a slow axis parallel to the absorption axis of the second polarizing plate located in the light outgoing side, and has Re(550) of:
100 nm<|Re(550)|<300 nm,
and Rth(550) of:
−600 nm<Rth(550)<−300 nm.

5. The liquid crystal display device according to claim 1, wherein the first retardation film has a slow axis vertical to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
300 nm<Rth(550)<600 nm, and
wherein the second retardation film has a slow axis vertical to the absorption axis of the second polarizing plate located in the light outgoing side, and has Re(550) of:
100 nm<|Re(550)|<300 nm,
and Rth(550) of:
300 nm<Rth(550)<600 nm.

6. The liquid crystal display device according to claim 1, wherein the first retardation film has a slow axis parallel to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
−600 nm<Rth(550)<−300 nm, and
wherein the second retardation film has a slow axis vertical to the absorption axis of the second polarizing plate located in the light outgoing side, and has Re(550) of:
100 nm<|Re(550)|<300 nm, and Rth(550) of:
300 nm<Rth(550)<600 nm.

7. The liquid crystal display device according to claim 1, wherein the first retardation film has a slow axis vertical to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
-600 nm<Rth(550)<−300 nm, and
wherein the second retardation film has a slow axis vertical to the absorption axis of the second polarizing plate located in the light outgoing side, and has Re(550) of:
100 nm<|Re(550)|<300 nm,
and Rth(550) of:
300 nm<Rth(550)<600 nm.

8. The liquid crystal display device according to claim 1, wherein the first retardation film has a slow axis vertical to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
−600 nm<Rth(550)<−300 nm, and
wherein the second retardation film has a slow axis parallel to the absorption axis of the second polarizing plate located in the light outgoing side, and has Re(550) of:
100 nm<|Re(550)|<300 nm,
and Rth(550) of:
−600 nm<Rth(550)<−300 nm.

9. The liquid crystal display device according to claim 1, wherein the first retardation film has a slow axis parallel to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
300 nm<Rth(550)<600 nm, and
wherein the second retardation film has a slow axis vertical to the absorption axis of the second polarizing plate located in the light outgoing side, and has Re(550) of:
100 nm<|Re(550)|<300 nm,
and Rth(550) of:
300 nm<Rth(550)<600 nm.

10. The liquid crystal display device according to claim 1, wherein the first retardation film has a slow axis parallel to the absorption axis of the second polarizing plate located in the light outgoing side, and has an in-plane retardation Re at a wavelength of 550 nm, Re(550), of:
100 nm<|Re(550)|<300 nm,
and a retardation Rth in the thickness direction at a wavelength of 550 nm, Rth(550), of:
300 nm<Rth(550)<600 nm, and
wherein the second retardation film has a slow axis parallel to the absorption axis of the second polarizing plate located in the light outgoing side, and has Re(550) of:
100 nm<|Re(550)|<300 nm,
and Rth(550) of:
−600 nm<Rth(550)<−300 nm.

11. The liquid crystal display device according to claim 1, wherein the liquid crystal display device is of a VA mode.
